(19) United States
(12) Patent Application Publication
(10) Pub. No.: US 2020/0056972 A1
(43) Pub. Date: Feb. 20, 2020

(54) PARTICLE SENSOR INCLUDING AT LEAST TWO LASER DOPPLER SENSORS

(71) Applicant: Robert Bosch GmbH, Stuttgart (DE)

(72) Inventors: Balazs Jatekos, Budapest (HU); Dick Scholten, Stuttgart (DE); Ingo Ramsteiner, Leonberg (DE); Robert Kakonyi, Kalocsa (HU); Stefan Pinter, Reutlingen (DE)

(21) Appl. No.: 16/348,332

(22) PCT Filed: Sep. 12, 2017
(86) PCT No.: PCT/EP2017/072856

§ 371 Date: May 8, 2019

(30) Foreign Application Priority Data
Nov. 9, 2016 (DE) 10 2016 221 989.8

(51) Int. Cl. G01N 15/02; G01N 15/14; G01S 17/87; G01S 7/499

(52) U.S. Cl. CPC G01N 15/0211; G01S 7/499; G01S 17/87; G01N 15/1456

(57) ABSTRACT

A particle sensor that includes a first laser Doppler sensor and at least a second laser Doppler sensor, as well as a control unit that is configured to carry out self-interference measurements with the first laser Doppler sensor and simultaneously with at least the second laser Doppler sensor.

### BACKGROUND INFORMATION

Optical particle sensors known from the related art utilize a separate beam source and beam evaluation unit. In addition, for movement of air, it is typically moved with the aid of a fan or a heating element for generating convection. Due to the associated beam path, this requires a larger overall design solely on account of the spatial separation of the transmitter and the receiver.

Semiconductor lasers are known in the related art, in which the light is emitted perpendicularly with respect to the main plane of a semiconductor chip, as a surface emitter or vertical cavity surface emitting laser (VCSEL). In addition, surface emitters having an external cavity (vertical external cavity surface emitting lasers (VECSELs)) are also known.

The document by Holger Moench et al., “VCSEL-based sensors for distance and velocity”, Proc. of SPIE Vol. 9766 97660A-1, describes a laser Doppler sensor from Philips that includes a self-interfering laser emitter (VCSEL) with a photodiode integrated into the cavity.

These VCSELs with integrated photodiode (ViPs) may be controlled in various ways in order to measure, for example, distances or velocities at specific points. The advantage of the integrated photodiode is that it is sensitive only to light which is specifically emitted. Thus, other light sources such as solar radiation cannot interfere with the detection principle.

A particle counter that includes such a laser Doppler sensor is provided in German patent application DE 102015207289, not previously published. The light of the laser is bundled around a focal point in a spatial area with the aid of a lens. When a particle is encountered in this spatial area, it scatters this light, which is then detected.

A scanning device that includes a VCSEL, a lens, and a micromirror is provided in German patent application DE 102015209418, not previously published. The light of the laser is bundled with the aid of the lens and deflected via the micromirror. A spatial area outside the scanning device may thus be sampled. When an object is encountered, it scatters this light, which is then detected. Thus, the measuring principle is to deflect the focus point of a light beam and thus scan a known volume of air.

When a particle that approaches the beam waist of a bundled laser beam is detected by self-interference (self-mixing interference (SMI)) in the beam-generating laser, the detected signal is a function of multiple parameters, in particular the particle size, the particle velocity, the position or precise trajectory relative to the beam focus, and the optical material properties of the particle.

In this regard, an unambiguous relationship between the measured raw signal and the properties of the particle is generally not present.

In addition, the system always views only one particle, i.e., is limited to a very small measuring volume. Of course, the beam may be scanned by a suitable device (a micromirror, for example), but then, only one piece of information per point in time is always obtained.

### SUMMARY

An object of the present invention is to obtain more information than is possible using a single SMI laser, in particular, to obtain unambiguous information concerning the particle properties.

The present invention relates to a particle sensor that includes a first laser Doppler sensor and at least a second laser Doppler sensor, as well as a control unit that is configured to carry out self-interference measurements with the first laser Doppler sensor and simultaneously with at least the second laser Doppler sensor. According to the present invention, two or more laser light sources are provided, in whose focus points SMI measurements may be carried out simultaneously but independently of one another.

One advantageous embodiment of the present invention provides that the first laser Doppler sensor includes a first optical system with a first external focal point and a first detection volume, and the second laser Doppler sensor includes a second optical system with a second external focal point and a second detection volume. As a result, detection volumes may be advantageously defined and provided at certain locations relative to one another.

One advantageous embodiment of the present invention provides that the first detection volume and the second detection volume overlap.

One advantageous embodiment of the present invention provides that the first laser Doppler sensor has a first polarization direction, and the second laser Doppler sensor has a second polarization direction that is different from the first polarization direction.

One advantageous embodiment of the present invention provides that the first detection volume and the second detection volume do not overlap.

One advantageous embodiment of the present invention provides that the first laser Doppler sensor or also the second laser Doppler sensor includes a movable beam-deflecting element, in particular a micromirror, as the result of which the first detection volume or also the second detection volume is placeable at variable locations.

One advantageous embodiment of the present invention provides that the first optical system includes a variably locatable first external focal point, or also the second optical system includes a variably locatable second external focal point, as the result of which the first detection volume or also the second detection volume is determinable at various locations.

One advantageous embodiment of the present invention provides that the first laser Doppler sensor or also the first optical system is optimized with regard to detection efficiency for a first particle size range, and the second laser Doppler sensor or also the second optical system is optimized with regard to detection efficiency for a second particle size range that is different from the first particle size range.

One advantageous embodiment of the present invention provides that the control unit for checking the plausibility of a sensor signal of the particle sensor is configured for checking time-resolved signal amplitudes of the first laser Doppler sensor and at least the second laser Doppler sensor with regard to the likelihood that a single particle has generated the signal for the first laser Doppler sensor and the second laser Doppler sensor in succession or at the same time.

One advantageous embodiment of the present invention involves a particle sensor with a plurality of laser Doppler sensors that are arranged for monitoring a flat area or a spatial area in a 2D array or 3D array.

A first advantageous embodiment of the present invention provides two or more laser sources whose focus points are spaced apart from one another at a fixed distance, but which are close enough to one another that their detection volumes overlap. This offers the advantage of being able to detect the same particle multiple times, and to better separate the effects of position and size of the particle by comparing the signals.

A second advantageous embodiment of the present invention provides two laser sources that observe overlapping, preferably identical, points in space. However, one of the sources is provided with a polarization rotating element. The advantage of this design is that information concerning the maintenance of polarization of the light that is scattered on the particle is additionally obtained, and the detected particles may be classified.

A third advantageous embodiment of the present invention provides two or more arrays, preferably an entire array, of laser sources that observe spatially separate points in space. The monitored volume is thereby increased.

### BRIEF DESCRIPTION OF THE DRAWINGS

FIGS. 1A through 1C show a schematic illustration of particles that move relative to the focus area of a light beam.

FIGS. 2A through 2C show a schematic illustration of particles that move relative to the focus areas of two light beams.

FIGS. 3A and 3B schematically show examples of signals of a particle sensor according to the present invention that includes two laser Doppler sensors.

FIG. 4 schematically shows a particle sensor according to the present invention.

### DETAILED DESCRIPTION

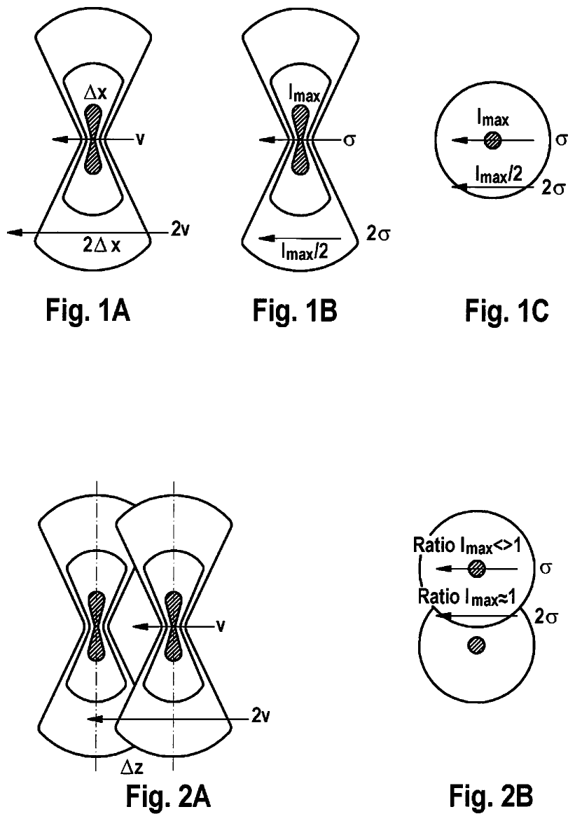

FIGS. 1A through 1C show a schematic illustration of particles that move relative to the focus area of a light beam. Hourglass-shaped contours represent lines of equal light intensity. Different particles and/or different trajectories may result in ambiguity in scattered light measurements.

FIG. 1A shows the ambiguity in velocity v when measuring scattered light pulse duration Δt (≈v/Δx) due to a longer transit distance Δx.

FIG. 1B shows the ambiguity in scattering efficiency σ of a particle when measuring pulse maximum Pₘₐₓ (∝σIₘₐₓ) through maximum beam intensity Iₘₐₓ during the transit.

FIG. 1C shows a cross-sectional illustration of FIG. 1B through the focus area along the beam direction. The locations of the particle traversal perpendicular to the beam direction are shown.

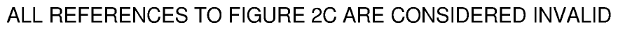

FIGS. 2A through 2C show a schematic illustration of particles that move relative to the focus areas of two light beams. The figures show how the ambiguity in the velocity and the scattering efficiency described in FIGS. 1A through 1C may be eliminated by the present invention.

FIG. 2A shows how the transit time of the particles between the two beam foci may be used instead of the transit time through the focus area of a single light beam for computing the velocity.

FIG. 2B shows a cross-sectional illustration of the FIG. 2A through the two focus areas along the beam direction. The locations of the particle traversal perpendicular to the beam direction are shown. The ratio of the pulse heights in the measuring signal allows the maximum beam intensity, and thus the scattering efficiency, to be determined.

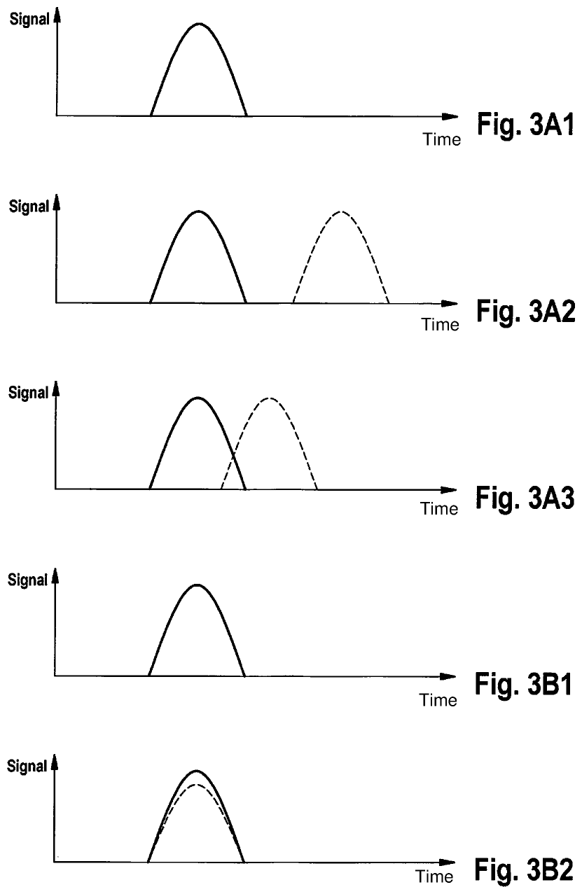

FIGS. 3A and 3B schematically show examples of signals of a particle sensor according to the present invention that includes two laser Doppler sensors. Examples of measuring curves are shown for illustrating the resolution of the ambiguity with the aid of the present invention according to FIGS. 2A and 2B, and for illustrating how appropriate algorithms may be derived.

Solid lines are signals from a first laser Doppler sensor (a VCSEL, for example). Dashed lines are signals from a second laser Doppler sensor (a VCSEL, for example).

FIG. 3A1 shows an ambiguous signal from the situation in FIG. 1A. FIGS. 3A2 and 3A3 show the resolution of ambiguity in the velocity determination. FIG. 3A2 illustrates the signal via a particle having velocity v that is measured with an arrangement according to FIG. 2A. FIG. 3A3 illustrates the signal via a particle having velocity 2v that is measured with an arrangement according to FIG. 2A.

FIG. 3B1 shows an ambiguous signal from the situation in FIG. 1B. FIGS. 3B2 and 3B3 show the resolution of the ambiguity in the determination of the scattering efficiency. It is illustrated in FIG. 3B2 that the signal through a particle having scattering efficiency σ is measured with an arrangement according to FIG. 2B. It is illustrated in FIG. 3B3 that the signal through a particle having velocity 2σ [sic; v] is measured with an arrangement according to FIG. 2B.

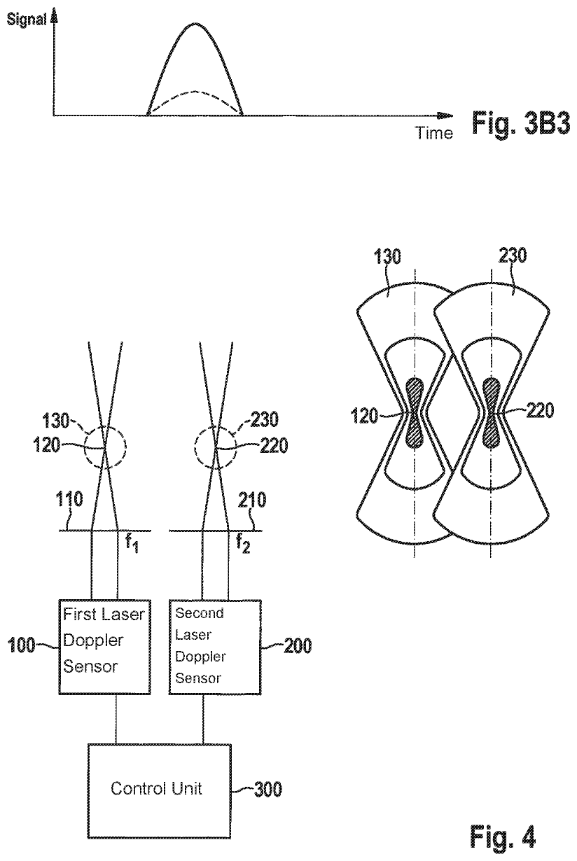

FIG. 4 schematically shows a particle sensor according to the present invention. The particle sensor includes a first laser Doppler sensor 100 and at least a second laser Doppler sensor 200, as well as a control unit 300 that is configured to carry out self-interference measurements with first laser Doppler sensor 100 and simultaneously with at least second laser Doppler sensor 200.

First laser Doppler sensor 100 includes a first optical system 110 with a first external focal point 120 and a first detection volume 130. Second laser Doppler sensor 200 includes a second optical system 210 with a second external focal point 220 and a second detection volume 230. The focal points and detection volumes are also illustrated in greater detail on the right side of the figure.

### First Exemplary Embodiment

In a first exemplary embodiment, the laser beams of the first laser Doppler sensor and of the second laser Doppler sensor are focused on two closely adjacent points in space. This is illustrated in the right portion of FIG. 4. When semiconductor sources with small emitting surfaces are used, it is advantageous here to use a shared optical system or also a shared substrate.

For determining PM 2.5, the entire particle mass of all particles having an aerodynamic diameter equivalent to a spherical particle having a diameter ≤2.5 μm in a volume, and the magnitude of the volume itself, must be known or must be measurable from the signals. To measure the volume, it may be advantageous to be able to measure the particle velocity relative to the light beam for a given beam profile. This results in the sampled volume per unit of time. There is a very strong correlation of the particle masses with scattering efficiency over the particle diameters. It may therefore be advantageous to be able to measure the particle diameter of the particles. For example, if an individual laser detects a particle for a certain time period Δt with maximum pulse height Pₘₐₓ, it is not possible on this basis to unambiguously measure the particle mass and the particle velocity relative to the light beam as illustrated in FIGS. 1A through 1C. If a particle now traverses one or more of these focus areas and generates signals there, the properties of the particle may be determined much more unambiguously, as illustrated in FIGS. 2A and 2B.

Apart from particle properties, it is also possible to improve the signal-to-noise ratio by comparing signals of multiple laser Doppler sensors, since it is easier to distinguish between noise (uncorrelated signals) and actual particle events (correlated signals).

To be able to measure particles having a very low scattering efficiency, in particular with very small particle diameters, with an adequate signal-to-noise ratio, it is advantageous to focus the light beam in order to obtain sufficient light density in the focus, and thus obtain a sufficient scattered light signal. However, strong focusing limits the illuminated volume in which particles may be detected. In order to detect very small particles as well as larger particles in a sufficient volume, it is advantageous to optimize the various laser Doppler sensors differently. In one advantageous implementation, a Doppler sensor is positioned on the optical axis in such a way that a small focal point is generated, and a second laser Doppler sensor is situated at a certain distance from the first laser Doppler sensor. Thus, the second laser Doppler sensor is not strongly focused, and will illuminate a larger volume where particles may be detected.

### Second Exemplary Embodiment

In a second exemplary embodiment, the laser beams of the first laser Doppler sensor and of the second laser Doppler sensor are focused on points that are preferably close together, ideally, on the same point. When semiconductor lasers with small emitting surfaces are used, it is advantageous here to use a shared optical system and/or a shared semiconductor substrate.

One of the lasers (the second laser, for example) is provided with an element (a λ/2 small plate, for example) that rotates the polarization plane of the emitted light by 45° (or 45°+n*90°). When the light returns into the laser (after reflection on a particle), this element must be passed through once again, which again rotates the polarization plane by the same magnitude. Thus, after it returns into the laser resonator, reflected light that maintains polarization is polarized perpendicularly with respect to the laser mode, and is no longer able to trigger an SMI effect.

Thus, the signal that is detected with the first laser is a measure for light intensity I_{P} that is reflected from the particle, with parallel polarization, to the original laser light (i.e., the reflection maintaining polarization), while the signal of the second laser is a measure for the reflected radiation perpendicular to the polarization of the laser. (I_{P}−I_{S})/(I_{P}+I_{S}) is thus the degree of polarization of the reflected radiation, and may be utilized for further classification of the particles.

EP 1 408 321 B1, for example, teaches that plant pollen may be distinguished from other fine particulate matter, since the light that is scattered by pollen is less polarized than that from other types of particulate matter.

It is also definitely meaningful here to compare the data, supplied by the sensor, to other sensors or to information available on the Internet. Such information may assist with classifying the measured particles. Pollen calendars that are available on the Internet check the plausibility of pollen detection and supplement the types of species. The position ascertained by GPS allows a comparison with map materials, and narrows down the particle species. For example, it is possible to deduce automobile emissions and tire abrasion near roadways, or soot and the like in industrial areas, pollen in grasslands or forests, or desert dust in deserts. The elevation above sea level, ascertained barometrically with the aid of a pressure sensor, or via GPS, likewise narrows down the particle species. A combination of the second exemplary embodiment with the first exemplary embodiment allows the determination of the particle size, which may be compared to pollen databases.

### Third Exemplary Embodiment

Multiple, preferably many, lasers allow the simultaneous monitoring of multiple separate points. In particular when VCSEL is used, cost-effective one- or two-dimensional arrays are conceivable.

Fairly large spatial areas may be covered here, even when moving parts (such as a scanning mirror) are dispensed with entirely.

Tracking of particle trajectories, provided that they extend in the focal plane, as well as very accurate velocity determinations are also conceivable in expanded 2D arrays. This would also allow, for example, ascertainment of wind speeds relative to the sensor, which would be of interest in automotive applications, for example.

All of the stated embodiments may be combined with a beam-deflecting element such as a micromirror, for example. Larger areas may then be sampled with the measuring spot, and more particles are detected than is possible via a stationary measuring point.

In principle, a measuring volume may also be scanned along the beam axis. Lenses whose focal length is appropriately dynamically changeable are suitable for this purpose.

### LIST OF REFERENCE NUMERALS

100 first laser Doppler sensor
110 first optical system
120 first external focal point
130 first detection volume
140 first polarization direction
200 second laser Doppler sensor
210 second optical system
220 second external focal point
230 second detection volume
240 second polarization direction
300 control unit
400 movable beam-deflecting element

1.-10. (canceled)

11. A particle sensor, comprising:
a first laser Doppler sensor; and
at least a second laser Doppler sensor; and
a control unit configured to carry out a self-interference measurement with the first laser Doppler sensor and simultaneously with at least the second laser Doppler sensor.

12. The particle sensor as recited in claim 11, wherein:
the first laser Doppler sensor includes a first optical system with a first external focal point and a first detection volume, and
the second laser Doppler sensor includes a second optical system with a second external focal point and a second detection volume.

13. The particle sensor as recited in claim 12, wherein the first detection volume and the second detection volume overlap.

14. The particle sensor as recited in claim 11, wherein:
the first laser Doppler sensor has a first polarization direction, and
the second laser Doppler sensor has a second polarization direction that is different from the first polarization direction.

15. The particle sensor as recited in claim 12, wherein the first detection volume and the second detection volume do not overlap.

16. The particle sensor as recited in claim 12, wherein:
at least one of the first laser Doppler sensor and the second laser Doppler sensor includes a movable beam-deflecting element as a result of which at least one of the first detection volume and the second detection volume is placeable at at least one location.

17. The particle sensor as recited in claim 16, wherein the movable beam-deflecting element is a micromirror.

18. The particle sensor as recited in claim 12, wherein at least one of the first optical system includes a variably locatable first external focal point and the second optical system includes a variably locatable second external focal point, and wherein as a result of which at least one of the first detection volume and the second detection volume is determinable at various locations.

19. The particle sensor as recited in claim 11, wherein:
at least one of the first laser Doppler sensor and the first optical system is optimized with regard to a first detection efficiency for a first particle size range, and
at least one of the second laser Doppler sensor and the second optical system is optimized with regard to a second detection efficiency for a second particle size range that is different from the first particle size range.

20. The particle sensor as recited in claim 11, wherein:
the control unit checks a plausibility of a sensor signal of the particle sensor and is configured for checking time-resolved signal amplitudes of the first laser Doppler sensor and at least the second laser Doppler sensor with regard to a likelihood that a single particle has generated a signal for the first laser Doppler sensor and the second laser Doppler sensor one of in succession and at the same time.

21. The particle sensor as recited in claim 11, the first laser Doppler sensor, the second laser Doppler sensor, and further laser Doppler sensors are arranged in one of a 2D array and a 3D array for monitoring one of a surface area and a spatial area.
